(19) United States
(12) Patent Application Publication
(10) Pub. No.: US 2026/0149512 A1
(43) Pub. Date: May 28, 2026

(54) METHOD FOR CALIBRATING FRONT-END SCATTERING PARAMETERS AND USER EQUIPMENT USING THE SAME

(71) Applicant: MEDIATEK INC., Hsinchu City (TW)

(72) Inventors: Li-Shan Cheng, Hsinchu City (TW); David Stephen Ivory-Cave, Cambridge (GB); Vivek Roy, Cambridge (GB); Bernard Mark Tenbroek, Cambridge (GB); Kuo-Hao Chen, Hsinchu City (TW)

(21) Appl. No.: 19/398,168

(22) Filed: Nov. 24, 2025

Related U.S. Application Data
(60) Provisional application No. 63/725,024, filed on Nov. 26, 2024.

(51) Int. Cl. H04B 17/12; H04B 17/21

(52) U.S. Cl. CPC H04B 17/12; H04B 17/221

(57) ABSTRACT

A method for calibrating front-end scattering parameters and a user equipment using the same are provided. The method for calibrating the front-end scattering parameters includes the following steps. At least three coupler reflection coefficients under are measured under at least three different tuner measurement control words. A plurality of tuner scattering parameters corresponding to the tuner measurement control words are obtained. The front-end scattering parameters are calibrated according to the at least three coupler reflection coefficients, and the tuner scattering parameters.

This application claims the benefit of U.S. Provisional application Ser. No. 63/725,024, filed Nov. 26, 2024, the disclosure of which is incorporated by reference herein in its entirety.

### TECHNICAL FIELD

The disclosure relates in general to a method for calibrating parameters and a user equipment using the same, and more particularly to a method for calibrating front-end scattering parameters and a user equipment using the same.

### BACKGROUND

The capability of precise environment detection plays a pivotal role in enhancing antenna performance. The accuracy of scenario detection is linked to various mobile device technologies, including antenna tuning and transmitting power control. Impedance measurement stands out as an effective method for antenna-related technologies, with front-end (FE) calibration being a crucial component.

Traditionally, calibrating front-end scattering parameters (S2P) requires a built-in or external calibration kit. In transmitter (Tx) systems, calibrating the scattering parameter of components necessitated removing the antenna or setting the output to a high isolation mode to avoid measurement inaccuracies due to the antenna's current state. This either renders the Tx unable to transmit signals properly or requires PCB rework.

### SUMMARY

The disclosure is directed to a method for calibrating front-end scattering parameters and a user equipment using the same. The calibration of the front-end scattering parameters utilizes a forward RF signal and a reverse RF signal. A novel calibration algorithm and procedure are capable of accurately calibrating the S2P of the front-end in environments with arbitrary and unknown antenna reflection rate, all without requiring the Tx to be set to high isolation. This method employs the tuner for calibration without the need for additional calibration kits, with the tuner set to a low isolation mode. Consequently, this enables signal transmission during calibration, allowing front-end calibration to be conducted concurrently with the mobile device's normal operation. The calibration flow enables real-time measurement of the front-end scattering parameters under network-assigned frequency scenarios, reducing the impact of variations such as part-to-part variation and temperature change. The method involves switching at least three tuner states without affecting signal transmission, thus ensuring accurate S-parameter (scattering parameter) calibration without using the antenna reflection coefficient.

According to one embodiment, a method for calibrating front-end scattering parameters is provided. The method for calibrating the front-end scattering parameters includes the following steps. At least three coupler reflection coefficients under are measured under at least three different tuner measurement control words. A plurality of tuner scattering parameters corresponding to the tuner measurement control words are obtained. The front-end scattering parameters are calibrated according to the at least three coupler reflection coefficients, and the tuner scattering parameters.

According to another embodiment, a user equipment is provided. The user equipment includes an antenna, a tuner, an RF Front-end circuit (RFFE), a coupler, a transmitting (Tx) modem and a feedback path unit. The tuner is connected to the antenna. The tuner is used for switching at least three different tuner measurement control words. The RF Front-end circuit (RFFE) is connected to the tuner. The coupler is connected to the RFFE. The transmitting (Tx) modem is connected to the coupler. The feedback path unit is connected to the RF Front-end circuit. The feedback path unit is used to measure at least three coupler reflection coefficients under at least three different tuner measurement control words, obtain a plurality of tuner scattering parameters corresponding to the tuner measurement control words, and calibrate the front-end scattering parameters according to the at least three coupler reflection coefficients, and the tuner scattering parameters.

### BRIEF DESCRIPTION OF THE DRAWINGS

FIG. 1 shows a schematic diagram of a user equipment according to one embodiment of the present disclosure.

FIG. 2 shows a plurality of tuner scattering parameters according to one embodiment of the present disclosure.

FIG. 3 shows a plurality of front-end scattering parameters according to one embodiment of the present disclosure.

FIG. 4 shows the measurement of the tuner scattering parameters according to one embodiment of the present disclosure.

FIG. 5 illustrates the selection of the tuner measurement control words according to one embodiment of the present disclosure.

FIG. 6 shows a flowchart of a method for calibrating the front-end scattering parameters according to one embodiment of the present disclosure.

FIG. 7 illustrates the steps in the FIG. 6.

FIG. 8 shows a flowchart of a method for calibrating the front-end scattering parameters according to another embodiment of the present disclosure.

FIG. 9 illustrates the steps in the FIG. 8.

FIG. 10 illustrates the hardware features for executing the automatic tuner measurement control word switching according to one embodiment of the present disclosure.

FIG. 11 illustrates a clock calibration for the automatic tuner measurement control word switching according to one embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

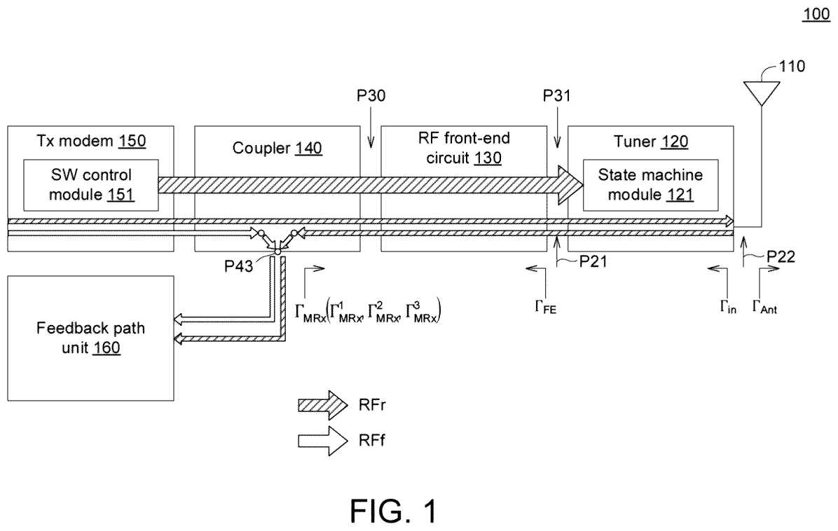

Please refer to FIG. 1, which shows a schematic diagram of a user equipment 100 according to one embodiment of the present disclosure. The user equipment 100 is, for example, a cellphone, a laptop, a Modem (modulator-demodulator) chip or a communication chip embedded in a mobile device, a robot and/or a vehicle.

The user equipment 100 includes, for example, an antenna 110, a tuner 120, an RF Front-end circuit (RFFE) 130, a coupler 140, a transmitting (Tx) modem 150 and a feedback path unit 160. In the user equipment 100, the antenna 110 serves as the interface between electromagnetic waves in the air and the electrical signals in a circuit. The antenna 110 is, for example but not limited to, a dipole antenna, a monopole antenna, a patch antenna, a helical antenna, a Yagi-Uda antenna, and/or a phased array antenna. The dipole antenna consists of two metal rods. The monopole antenna has a single conductor, and is often mounted over a ground plane. The patch antenna is flat, and used in mobile and/or IoT devices. The helical antenna is coil-shaped, and is good for circular polarization. The Yagi-Uda antenna is directional, and is used in TV and point-to-point links. The phased array antenna has beam-steering, and is used in radar and 5G systems.

The tuner 120 may be coupled to the antenna 110. The tuner 120 may be the first stage after the antenna 110. The tuner 120 is used to select a specific frequency or channel from the broad range of received RF signals. It adjusts the receiver circuit to match the desired signal frequency and often includes filtering and amplification. The tuner 120 is, for example but not limited to, an analog tuner, a digital tuner, a wideband tuner and/or a closed-loop tuner. The analog tuner is manually tuned using variable capacitors or inductors. The digital tuner is electronically controlled, and use PLL (phase-locked loop) for precise tuning. The wideband tuner could cover a large range of frequencies without switching components. The closed-loop tuner could be adjusted in real time based on feedback from signal quality metrics.

The RF front-end circuit 130 may be coupled to the tuner 120. The tuner 120 may be coupled between the antenna 110 and the RF front-end circuit 130. The RF front-end circuit 130 processes the raw RF signal by filtering, amplifying, and converting it to an intermediate frequency (IF) or baseband for demodulation. The RF front-end circuit 130 may comprise a low-noise amplifier (LNA), a bandpass filter, a mixer and/or a switch/duplexer. The LNA is used to boost weak signals with minimal added noise. The bandpass filter is used to select the desired frequency band and reject out-of-band noise. The mixer is used to convert RF to a lower frequency (IF) by mixing it with a local oscillator signal. The switch/duplexer is used to separate Tx and Rx paths, especially in full-duplex systems.

The RF front-end circuit 130 is, for example, but not limited to, a discrete RF front-end, an integrated front-end module (FEM) and/or a software-defined RF front-end. The discrete RF front-end is made from separate components, and is customizable. The integrated front-end module is compact modules used in smartphones, Wi-Fi, etc. The software-defined RF front-end allows dynamic reconfiguration for different bands and standards.

The coupler 140 is a passive RF component used to extract a small portion of the signal from a transmission path without disturbing the main signal flow. It's commonly used in power monitoring, signal sampling, and feedback loops. The coupler 140 is usually used to monitor transmitted or reflected power, enable feedback for closed-loop systems (e.g., power control, beamforming), or protect components, such as Power Amplifier (PA), by detecting mismatch/reflection. The coupler 140 is, for example but not limited to, a directional coupler, a hybrid coupler, a dual-directional coupler or a sampling coupler.

The Tx modem 150 is used to demodulate the incoming signal-extracting digital data from the analog waveform. It also handles error correction, synchronization, and decoding. The Tx modem 150 is, for example but not limited to, an ASK/FSK/PSK demodulator, a QAM demodulator, an OFDM demodulator and/or a software-defined modem. The ASK/FSK/PSK demodulator is used in simple digital systems like RFID or low-power IoT. The QAM demodulator is common in high-speed data systems like LTE and Wi-Fi. The OFDM demodulator is used in modern broadband systems (4G/5G, Wi-Fi). The software-defined modem is implemented in DSP or FPGA, and supports multiple modulation types.

The feedback path unit 160 is a circuit route where a sample of the signal (usually from the coupler) is sent back to a previous stage. The feedback path unit 160 is typically used for calibration, correction, gain control, impedance tuning, or beamforming adjustments. The hardware implementation of the feedback path unit 160 could be achieved through various options, including but not limited to Monitoring Receiver (MRx). The feedback path unit 160 is, for example but not limited to, an analog feedback path unit, a digital feedback path unit, a closed-loop feedback path unit, or an open-loop feedback path unit.

As shown in the FIG. 1, there are an antenna reflection coefficient Γ_{Ant}, a front-end reflection coefficient Γ_{FE}, a tuner reflection coefficient Γᵢₙ and a coupler reflection coefficient Γ_{MRx}.

The antenna reflection coefficient Γ_{Ant} measures how much of the incoming signal is reflected back due to impedance mismatch between the antenna and the connected circuitry (typically the RF front-end). It's a key indicator of how efficiently the antenna is transferring power to the system. The low reflection coefficient Γ_{Ant} means good impedance matching (minimal signal loss). A high reflection coefficient Γ_{Ant} means poor matching (more signal is reflected back).

The front-end reflection coefficient Γ_{FE} represents how much signal is reflected at an RFFE output port P31 of the RF front-end circuit 130 due to mismatch with the antenna 110 or the tuner 120. Even if the antenna 110 is well-designed, a mismatch at the RF front-end circuit 130 could still degrade system performance.

The tuner reflection coefficient Γᵢₙ refers to the reflection coefficient at a turner output port P22 of the tuner 120. The tuner reflection coefficient Γᵢₙ means how well the tuner 120 is compensating for mismatch conditions.

The coupler reflection coefficient Γ_{MRx} refers to the reflection coefficient at the coupler 140. The coupler reflection coefficient Γ_{MRx} represents impedance mismatch between the coupler 140 and the Monitoring Receiver (MRx).

The Tx modem 150 includes a software (SW) control module 151. The SW control module 151 is a hardware implementation of a software control which can be achieved through various options, including but not limited to Mobile Industry Processor Interface Radio Frequency Front-End (MIPI RFFE).

The tuner 120 includes a state machine module 121. The state machine module 121 is a hardware implementation of a state machine which can be achieved through various options, including but not limited to Microcontroller, Complex Programmable Logic Device (CPLD), and Field-Programmable Gate Array (FPGA).

In the present disclosure, a plurality of front-end scattering parameters e₀₀, e₁₀, e₀₁, e₁₁ (shown in the FIG. 3), could be calibrated by using the tuner 120. An algorithm is provided to calibrate the front-end scattering parameters e₀₀, e₁₀, e₀₁, e₁₁ of the RFFE 130 by using the tuner 120 under arbitrary and unknown antenna impedance.

Moreover, an algorithm is further provided for calibrating the antenna reflection coefficient Γ_{Ant} by the tuner 120 without using front-end scattering parameters e₀₀, e₁₀, e₀₁, e₁₁.

Besides, a hardware design guideline for the tuner 120 is provided in the present disclosure. The proposed method is provided for simultaneously calibrating the front-end scattering parameters e₀₀, e₁₀, e₀₁, e₁₁ using the transmitting signal without affecting signal transmission.

For calibrating the front-end scattering parameters e₀₀, e₁₀, e₀₁, e₁₁ in real-time, required data includes at least three coupler reflection coefficients Γ_{MRx} and tuner scattering parameters

$${S}_{11}^{x} , \qquad {S}_{21}^{x} , \qquad {S}_{12}^{x} , \qquad {S}_{22}^{x}$$

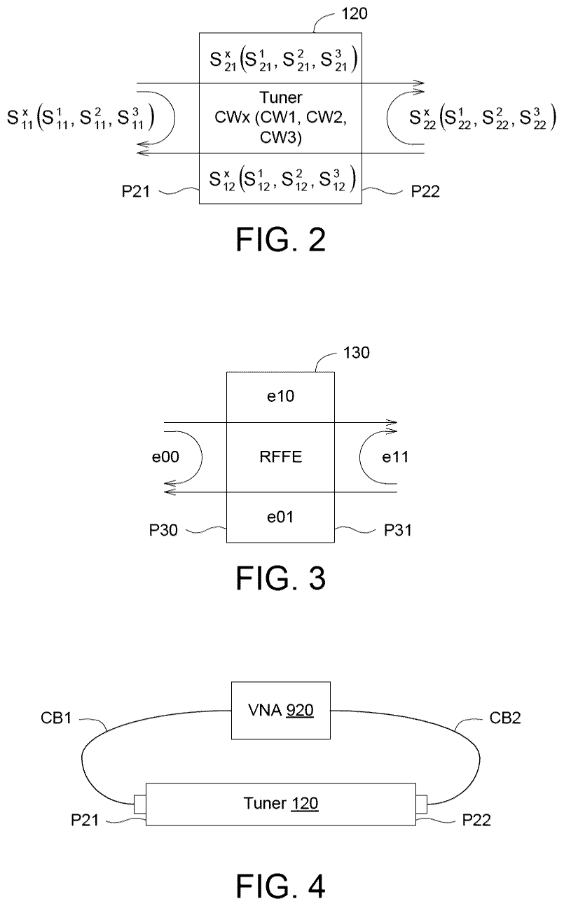

(shown in the FIG. 2) under at least three different tuner measurement control words CWx. The superscript “x” of the tuner scattering parameters

$${S}_{11}^{x} , \qquad {S}_{21}^{x} , \qquad {S}_{12}^{x} , \qquad {S}_{22}^{x}$$

represents the tuner measurement control word CWx.

The at least three coupler reflection coefficients Γ_{MRx} are measured by the feedback path unit 160 under different tuner measurement control words CWx. The tuner scattering parameters

$${S}_{11}^{x} , \qquad {S}_{21}^{x} , \qquad {S}_{12}^{x} , \qquad {S}_{22}^{x}$$

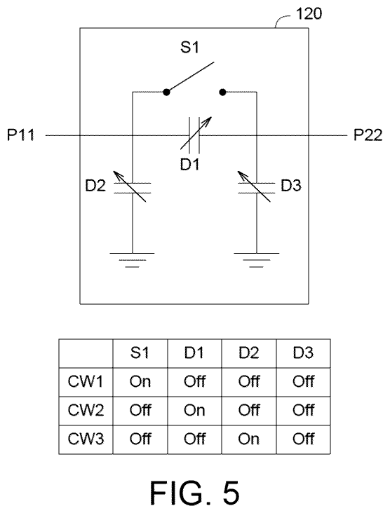

under different tuner measurement control words CWx could be estimated by using offline simulation or measurement by equipment, such as VNA (vector network analyzer). In some embodiments, please refer to FIGS. 2 and 5, the tuner 120 can perform measurements to obtain the scattering parameters

$${S}_{11}^{x} , \qquad {S}_{21}^{x} , \qquad {S}_{12}^{x} , \qquad {S}_{22}^{x}$$

before being coupled to the antenna 110 and the RF front-end circuit 130. In some embodiments, the at least three coupler reflection coefficients Γ_{MRx} are measured by the feedback path unit 160 under different tuner measurement control words CWx after the tuner 120 has been coupled to the antenna 110 and the RF front-end circuit 130.

To prevent internal channel from changing, the RF signal transmitting path in both of the RFFE 130 and the Tx modem 150 should be fixed during the reception for all tuner measurement control word CWx in the feedback path.

To prevent antenna reflection coefficient Γ_{Ant} from changing, the coupler reflection coefficient Γ_{MRx}, such as

$${Γ}_{MRx}^{1} , {Γ}_{M R x}^{2} , and {Γ}_{M R x}^{3} ,$$

measured by feedback path for tuner measurement control words should be measured within 0.1 second in a real-time scenario. The coupler reflection coefficients Γ_{MRx} are measured by the feedback path unit 160 under different tuner measurement control words CWx.

Please refer to FIG. 2, which shows the tuner scattering parameters

$${S}_{11}^{x} , \qquad {S}_{21}^{x} , \qquad {S}_{12}^{x} , \qquad {S}_{22}^{x}$$

according to one embodiment of the present disclosure. The superscript “x” of the tuner scattering parameters

$${S}_{11}^{x} , \qquad {S}_{21}^{x} , \qquad {S}_{12}^{x} , \qquad {S}_{22}^{x}$$

represents the tuner measurement control word CWx. For example, the tuner scattering parameters

$${S}_{11}^{1} , \qquad {S}_{21}^{1} , \qquad {S}_{12}^{1} , \qquad {S}_{22}^{1}$$

are the reflection coefficients and transmission coefficients of the tuner 120 when the tuner input port P21 and the tuner output port P22 connect with 50Ω (Z₀) and the tuner 120 is set at the tuner measurement control word CW1; the tuner scattering parameters

$${S}_{11}^{2} , \qquad {S}_{21}^{2} , \qquad {S}_{12}^{2} , \qquad {S}_{22}^{2}$$

are the reflection coefficients and transmission coefficients of the tuner 120 when the tuner input port P21 and the turner output port P22 connect with 50Ω (Z₀) and the tuner 120 is set at the tuner measurement control word CW2; and the tuner scattering parameters

$${S}_{11}^{3} , \qquad {S}_{21}^{3} , \qquad {S}_{12}^{3} , \qquad {S}_{22}^{3}$$

are the reflection coefficients and transmission coefficients of the tuner 120 when the tuner input port P21 and the tuner output port P22 connect with 50Ω (Z₀) and the tuner 120 is set at the tuner measurement control word CW3. In some embodiments, the value of 50Ω for Z₀ is for illustrative purposes only. Z₀ can have any resistance value and is not limited to 50Ω (ohms). Z₀ can be other predetermined value.

The tuner scattering parameter

$${S}_{11}^{x} \qquad ( {S}_{11}^{1} , \qquad {S}_{11}^{2} or \qquad {S}_{11}^{3} )$$

is the reflection coefficient at a tuner input port P21, representing the proportion of the wave entering the tuner input port P21 that is reflected back to the tuner input port P21.

The tuner scattering parameter

$${S}_{21}^{x} \qquad ( {S}_{21}^{1} , \qquad {S}_{21}^{2} or \qquad {S}_{21}^{3} )$$

is the transmission coefficient from the tuner input port P21 to the turner output port P22, representing the proportion of the wave entering the tuner input port P21 that is transmitted to the turner output port P22.

The tuner scattering parameter

$${S}_{12}^{x} \qquad ( {S}_{12}^{1} , \qquad {S}_{12}^{2} or \qquad {S}_{12}^{3} )$$

is the transmission coefficient from the turner output port P22 to the tuner input port P21, representing the proportion of the wave entering the turner output port P22 that is transmitted to the port P21.

The tuner scattering parameter

$${S}_{22}^{x} \qquad ( {S}_{22}^{1} , \qquad {S}_{22}^{2} or \qquad {S}_{22}^{3} )$$

is the reflection coefficient at the turner output port P22, representing the proportion of the wave entering the turner output port P22 that is reflected back to the turner output port P22.

Please refer to FIG. 3, which shows the front-end scattering parameters e₀₀, e₁₀, e₀₁, e₁₁ according to one embodiment of the present disclosure. The front-end scattering parameters e₀₀, e₁₀, e₀₁, e₁₁ are the reflection coefficients and transmission coefficients of the RFFE 130 when an RFFE input port P30 and the RFFE output port P31 of the RFFE 130 connect with 50Ω (Z₀).

The front-end scattering parameter e₀₀ is a reflection coefficient at the RFFE input port P30 of the RFFE 130, representing a proportion of a wave entering the RFFE input port P30 of the RFFE 130 that is reflected back to the RFFE input port P30 of the RFFE 130.

The front-end scattering parameter e₁₀ is a transmission coefficient from the RFFE input port P30 of the RFFE 130 to the RFFE output port P31 of the RFFE 130, representing a proportion of a wave entering the RFFE input port P30 of the RFFE 130 that is transmitted to the RFFE output port P31 of the RFFE 130.

The front-end scattering parameter e₀₁ is a transmission coefficient from the RFFE output port P31 of the RFFE 130 to the RFFE input port P30 of the RFFE 130, representing a proportion of a wave entering the RFFE output port P31 of the RFFE 130 that is transmitted to the RFFE input port P30 of the RFFE 130.

The front-end scattering parameter e₁₁ is a reflection coefficient at the RFFE output port P31 of the RFFE 130, representing a proportion of a wave entering the RFFE output port P31 of the RFFE 130 that is reflected back to the RFFE output port P31 of the RFFE 130.

The front-end scattering parameter e₀₁ is equivalent to the front-end scattering parameter e₁₀, so that the front-end scattering parameters e₀₀, e₁₀, e₀₁, e₁₁ could be considered as three variables.

Please refer to FIG. 4, which shows the measurement of the tuner scattering parameters

$${S}_{11}^{1} , \qquad {S}_{11}^{2} , \qquad {S}_{11}^{3} , \qquad {S}_{21}^{1} , \qquad {S}_{21}^{2} , \qquad {S}_{21}^{3} , \qquad {S}_{12}^{1} , \qquad {S}_{12}^{2} , \qquad {S}_{12}^{3} , \qquad {S}_{22}^{1} , \qquad {S}_{22}^{2} , \qquad {S}_{22}^{3}$$

according to one embodiment of the present disclosure. The tuner scattering parameters

$${S}_{11}^{1} , \qquad {S}_{11}^{2} , \qquad {S}_{11}^{3} , \qquad {S}_{21}^{1} , \qquad {S}_{21}^{2} , \qquad {S}_{21}^{3} , \qquad {S}_{12}^{1} , \qquad {S}_{12}^{2} , \qquad {S}_{12}^{3} , \qquad {S}_{22}^{1} , \qquad {S}_{22}^{2} , \qquad {S}_{22}^{3}$$

could be estimated by using offline simulation or measured by equipment, such as but not limited to the vector network analyzer (VNA) 920.

One example of the measurement of the tuner scattering parameters

$${S}_{11}^{1} , \qquad {S}_{11}^{2} , \qquad {S}_{11}^{3} , \qquad {S}_{21}^{1} , \qquad {S}_{21}^{2} , \qquad {S}_{21}^{3} , \qquad {S}_{12}^{1} , \qquad {S}_{12}^{2} , \qquad {S}_{12}^{3} , \qquad {S}_{22}^{1} , \qquad {S}_{22}^{2} , \qquad {S}_{22}^{3}$$

includes disconnecting the tuner 120 with the RF front-end circuit 130 and the antenna 110, soldering the cables CB1, CB2 of the VNA 920 with the tuner input port P21 and the turner output port P22 respectively; and measuring the tuner scattering parameters

$$\begin{matrix}{S}_{11}^{1} , & {S}_{11}^{2} , & {S}_{11}^{3} , & {S}_{21}^{1} , & {S}_{21}^{2} , & {S}_{21}^{3} , & {S}_{12}^{1} , & {S}_{12}^{2} , & {S}_{12}^{3} , & {S}_{22}^{1} , & {S}_{22}^{2} , & {S}_{22}^{3}\end{matrix} .$$

In some embodiments, please refer to FIGS. 2 and 5, the tuner 120 can be configured to perform measurements under different states (e.g., using tuner measurement control words CW1, CW2 and CW3) to obtain the corresponding tuner scattering parameters. For example, the tuner 120 can perform measurements to obtain the scattering parameters before being coupled to the antenna 110 and the RF front-end circuit 130. In some embodiments, the tuner 120 is first set to the first state via the tuner measurement control word CW1 to measure and obtain the scattering parameters

$${S}_{11}^{1} , \qquad {S}_{21}^{1} , \qquad {S}_{12}^{1} , \qquad {S}_{22}^{1} .$$

Then, it is set to the second state via the tuner measurement control word CW2 to measure and obtain the scattering parameters

$${S}_{11}^{2} , \qquad {S}_{21}^{2} , \qquad {S}_{12}^{2} , \qquad {S}_{22}^{2} .$$

Then, it is set to the third state via the tuner measurement control word CW3 to measure and obtain the scattering parameters

$${S}_{11}^{3} , \qquad {S}_{21}^{3} , \qquad {S}_{12}^{3} , \qquad {S}_{22}^{3} .$$

After completing these steps, the tuner 120 is coupled to the antenna 110 and the RF front-end circuit 130. Subsequently, the tuner 120 is set to the first state via the tuner measurement control word CW1, and the Tx modem 150 transmits a signal, and the coupler reflection coefficient

$${Γ}_{M R x}^{1}$$

is measured (and/or calculated) by following method. Next, the tuner 120 is set to the second state via the tuner measurement control word CW2, and the Tx modem 150 transmits a signal, and the coupler reflection coefficient

$${Γ}_{M R x}^{2}$$

is measured (and/or calculated) by following method. Next, the tuner 120 is set to the third state via the tuner measurement control word CW3, and the Tx modem 150 transmits a signal, and the coupler reflection coefficient

$${Γ}_{M R x}^{3}$$

is measured (and/or calculated) by following method. In some embodiments, the above three signals transmitted by the Tx modem 150 transmits are known signals.

For measuring the tuner scattering parameters

$${S}_{11}^{1} , \qquad {S}_{11}^{2} , \qquad {S}_{11}^{3} ,$$

a known signal is sent into the tuner 120 by a cable CB1 and the reflected signal is measured by the cable CB1.

For measuring the tuner scattering parameters

$${S}_{21}^{1} , \qquad {S}_{21}^{2} , \qquad {S}_{21}^{3} ,$$

a known signal is sent into the tuner 120 by the cable CB1 and the reflected signal is measured by a cable CB2.

For measuring the tuner scattering parameters

$${S}_{12}^{1} , \qquad {S}_{12}^{2} , \qquad {S}_{12}^{3} ,$$

a known signal is sent into the tuner 120 by the cable CB2 and the reflected signal is measured by the cable CB1.

For measuring the tuner scattering parameters

$$\begin{matrix}{S}_{22}^{1} , & {S}_{22}^{2} , & {S}_{22}^{3}\end{matrix} ,$$

a known signal is sent into the tuner 120 by the cable CB2 and the reflected signal is measured by the cable CB2.

Based on above, the tuner scattering parameters

$${S}_{11}^{1} , \qquad {S}_{11}^{2} , \qquad {S}_{11}^{3} , \qquad {S}_{21}^{1} , \qquad {S}_{21}^{2} , \qquad {S}_{21}^{3} , \qquad {S}_{12}^{1} , \qquad {S}_{12}^{2} , \qquad {S}_{12}^{3} , \qquad {S}_{22}^{1} , \qquad {S}_{22}^{2} , \qquad {S}_{22}^{3}$$

could be measured at offline.

As shown in the FIG. 1, the estimation of coupler reflection coefficient Γ_{MRx} is illustrated as follows. The coupler reflection coefficient Γ_{MRx} represents the proportion of the forward RF signal and reverse RF signal measured by feedback path unit 160. The impedance of feedback path unit 160 is 50Ω. For example, the coupler reflection coefficient Γ_{MRx} could be obtain through the following equation (1).

$${Γ}_{M R x} = \frac{Reverse RF signal RFr}{Forward RF signal RFf} \qquad ( 1 )$$

The coupler 140 separates the forward RF signal RFf (or incident signal) and the reverse RF signal RFr (or reflected signal). The forward RF signal RFf travels towards the RFFE 130, and the reflected forward RF signal RFf from the RFFE 130 will be coupled to a coupled port P43.

The feedback path unit 160 connected to the coupled port P43 measures the magnitude and the phase of the reflected forward RF signal RFf.

The following describes the algorithm for the calibration of the front-end scattering parameters e₀₀, e₁₀, e₀₁, e₁₁. The algorithm for the calibration of the front-end scattering parameters e₀₀, e₁₀, e₀₁, e₁₁ could be performed offline, real-time, or in a hybrid mode, depending on the hardware capabilities and the type of the user requirement 100.

The antenna reflection coefficient Γ_{Ant} is a constant during the calibration. The antenna reflection coefficient

$${Γ}_{Ant}^{a}$$

under the tuner measurement control word CWa could be represented by the following equations (2) to (5) with the coupler reflection coefficient

$${Γ}_{M R x}^{a}$$

under the tuner measurement control word CWa, de-embedding the tuner scattering parameter Sⁿ under the tuner measurement control word CWa.

$${Γ}_{Ant}^{a} = \frac{\frac{{Γ}_{M R x}^{a} - y}{x - z {Γ}_{M R x}^{a}} - {S}_{11}^{a}}{{S}_{12}^{a} {S}_{21}^{a} + {S}_{22}^{a} ( \frac{{Γ}_{M R x}^{a} - y}{x - z {Γ}_{M R x}^{a}} - {S}_{11}^{a} )} \qquad ( 2 )$$

$$x = {e}_{01} {e}_{10} - {e}_{00} {e}_{11} \qquad ( 3 )$$

$$y = {e}_{00} \qquad ( 4 )$$

$$z = - {e}_{11} \qquad ( 5 )$$

x is the RFFE scattering parameter determinant (Δe=e₀₁e₁₀(insertion loss)−e₀₀e₁₁(FE reflection rate)). Or, x could be represent a determinant of a scattering parameter matrix E, as shown in the following equation (6).

$$E = [ \begin{matrix}{e}_{00} & {e}_{01} \\ {e}_{10} & {e}_{11}\end{matrix} ] \qquad ( 6 )$$

y is the front-end scattering parameter e₀₀ at the RFFE input port P30 of the RFFE 130.
z is the negative front-end scattering parameter −e₁₁ at the RFFE output port P31 of the RFFE 130.

The total number of calibrating setting can be an arbitrary value higher than 2. Based on the fact that the antenna reflection coefficient Γ_{Ant} is constant during calibration, the antenna reflection coefficient

$${Γ}_{A n t}^{a}$$

under the tuner measurement control word CWa and the antenna reflection coefficient

$${Γ}_{A n t}^{b}$$

under the tuner measurement control word CWb satisfies the following equation (7).

$${Γ}_{A n t}^{a} - {Γ}_{A n t}^{b} = 0 \qquad ( 7 )$$

The equation (7) is equivalent to the following equation (8).

$$\frac{\frac{{Γ}_{M R x}^{a} - y}{x - z {Γ}_{M R x}^{a}} - {S}_{11}^{a}}{{S}_{12}^{a} {S}_{21}^{a} + {S}_{22}^{a} ( \frac{{Γ}_{M R x}^{a} - y}{x - z {Γ}_{M R x}^{a}} - {S}_{11}^{a} )} - \frac{\frac{{Γ}_{M R x}^{b} - y}{x - z {Γ}_{M R x}^{b}} - {S}_{11}^{b}}{{S}_{12}^{b} {S}_{21}^{b} + {S}_{22}^{b} ( \frac{{Γ}_{M R x}^{b} - y}{x - z {Γ}_{M R x}^{b}} - {S}_{11}^{b} )} = 0 \qquad ( 8 )$$

To improve the calibration accuracy, the coupler reflection coefficients Γ_{MRx} could be measured under different tuner measurement control words and the front-end scattering parameters e₀₀, e₁₀, e₀₁, e₁₁ could be calibrated through a system of equations. For example, three different tuner measurement control words CW1, CW2, CW3 are used to represent the following equation (9).

$$\{ \begin{matrix}\frac{\frac{{Γ}_{M R x}^{1} - y}{x - z {Γ}_{M R x}^{1}} - {S}_{11}^{1}}{{S}_{12}^{1} {S}_{21}^{1} + {S}_{22}^{1} ( \frac{{Γ}_{M R x}^{1} - y}{x - z {Γ}_{M R x}^{1}} - {S}_{11}^{1} )} - \frac{\frac{{Γ}_{M R x}^{2} - y}{x - z {Γ}_{M R x}^{2}} - {S}_{11}^{2}}{{S}_{12}^{2} {S}_{21}^{2} + {S}_{22}^{2} ( \frac{{Γ}_{M R x}^{2} - y}{x - z {Γ}_{M R x}^{2}} - {S}_{11}^{2} )} = 0 \\ \frac{\frac{{Γ}_{M R x}^{2} - y}{x - z {Γ}_{M R x}^{2}} - {S}_{11}^{2}}{{S}_{12}^{2} {S}_{21}^{2} + {S}_{22}^{2} ( \frac{{Γ}_{M R x}^{2} - y}{x - z {Γ}_{M R x}^{2}} - {S}_{11}^{2} )} - \frac{\frac{{Γ}_{M R x}^{3} - y}{x - z {Γ}_{M R x}^{3}} - {S}_{11}^{3}}{{S}_{12}^{3} {S}_{21}^{3} + {S}_{22}^{3} ( \frac{{Γ}_{M R x}^{3} - y}{x - z {Γ}_{M R x}^{3}} - {S}_{11}^{3} )} = 0 \\ \frac{\frac{{Γ}_{M R x}^{3} - y}{x - z {Γ}_{M R x}^{3}} - {S}_{11}^{3}}{{S}_{12}^{3} {S}_{21}^{3} + {S}_{22}^{3} ( \frac{{Γ}_{M R x}^{3} - y}{x - z {Γ}_{M R x}^{3}} - {S}_{11}^{3} )} - \frac{\frac{{Γ}_{M R x}^{1} - y}{x - z {Γ}_{M R x}^{1}} - {S}_{11}^{1}}{{S}_{12}^{1} {S}_{21}^{1} + {S}_{22}^{1} ( \frac{{Γ}_{M R x}^{1} - y}{x - z {Γ}_{M R x}^{1}} - {S}_{11}^{1} )} = 0\end{matrix} \qquad ( 9 )$$

By solving the simultaneous equations (9), x, y, z could be obtained, and then the front-end scattering parameters e₀₀, e₁₀, e₀₁, e₁₁ could be obtained through the equations (3) to (5).

Further, by solving the front-end scattering parameters e₀₀, e₁₀, e₀₁, e₁₁, the antenna reflection coefficient Γ_{Ant} could be derived by the following equation (10).

$${Γ}_{Ant}^{a} = \frac{\frac{{Γ}_{M R x}^{a} - y}{x - z {Γ}_{M R x}^{a}} - {S}_{11}^{a}}{{S}_{12}^{a} {S}_{21}^{a} + {S}_{22}^{a} ( \frac{{Γ}_{M R x}^{a} - y}{x - z {Γ}_{M R x}^{a}} - {S}_{11}^{a} )} \qquad ( 10 )$$

Please refer to FIG. 5, which illustrates the selection of the tuner measurement control words CW1, CW2, CW3 according to one embodiment of the present disclosure. The selection of the tuner measurement control words CW1, CW2, CW3 is highly dependent to the design of tuner RF hardware. To prevent receiving signal quality degradation, it is suggested, but not limit, to select the tuner measurement control words CW1, CW2, CW3 with insertion loss lower than 1 dB.

To ensure the linear independence of the tuner measurement control words CW1, CW2, CW3, firstly, the selected the tuner measurement control words CW1, CW2, CW3 should satisfy that a tuner scattering parameter determinant A is unequal to 0, shown as the following equation (11).

$$Δ = \vert \begin{matrix}{S}_{11}^{1} & {S}_{12}^{1} {S}_{21}^{1} & {S}_{22}^{1} \\ {S}_{11}^{2} & {S}_{12}^{2} {S}_{21}^{2} & {S}_{22}^{2} \\ {S}_{11}^{3} & {S}_{12}^{3} {S}_{21}^{3} & {S}_{22}^{3}\end{matrix} \vert \neq 0 \qquad ( 11 )$$

Secondly, selected tuner measurement control words CW1, CW2, CW3 should satisfy that a tuner reflection coefficient difference d under the supported antenna reflection coefficient Γ_{Ant} is unequal to 0, shown as the following equation (12).

$$d = \vert {Γ}_{i n}^{1} - {Γ}_{i n}^{2} \vert \neq 0 \qquad ( 12 )$$

For example, the tuner 120 may be composed of a switch S1, and three variable capacitors D1, D2, and D3. When the switch S1 is turned on and the variable capacitors D1, D2, and D3 are turned off (or kept at low), the tuner 120 is controlled at the tuner measurement control word CW1. When the switch S1 is turned off, the variable capacitor D1 is turned on (or kept at high), and the variable capacitors D2, D3 are turned off (or kept at low), the tuner 120 is controlled at the tuner measurement control word CW2. When the switch S1 is turned off, the variable capacitors D1, D3 are turned off (or kept at low), and the variable capacitor D2 is turned on (or kept at high), the tuner 120 is controlled at the tuner measurement control word CW3.

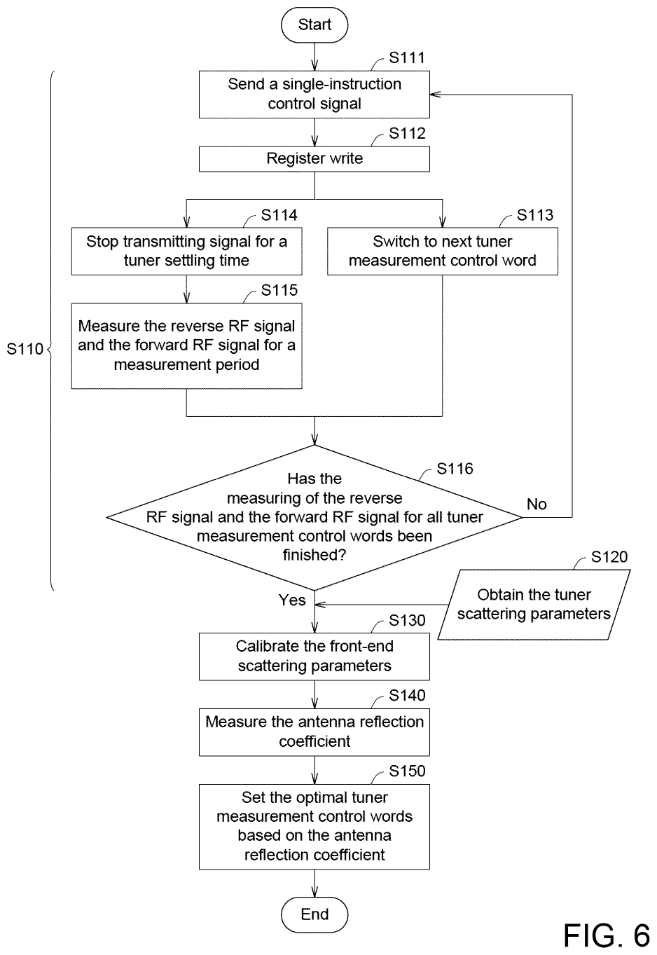

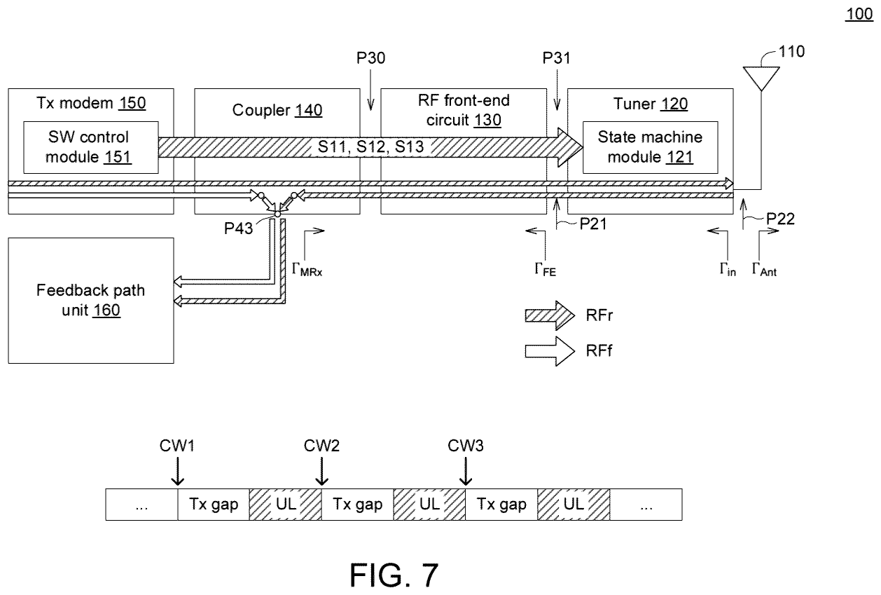

Please refer to FIGS. 6 and 7. FIG. 6 shows a flowchart of a method for calibrating the front-end scattering parameters e₀₀, e₁₀, e₀₁, e₁₁ according to one embodiment of the present disclosure. FIG. 7 illustrates the steps in the FIG. 6. The method for calibrating the front-end scattering parameters e₀₀, e₁₀, e₀₁, e₁₁ in the FIG. 6 includes steps S110 to S150. The step S110 includes steps S111 to S116.

In the step S110, as shown in the FIG. 7, the feedback path unit 160 measures at least three coupler reflection coefficients

$${Γ}_{M R x}^{1} , \qquad {Γ}_{M R x}^{2} , \qquad {Γ}_{M R x}^{3} .$$

The at least three coupler reflection coefficients

$${Γ}_{M R x}^{1} , \qquad {Γ}_{M R x}^{2} , \qquad {Γ}_{M R x}^{3}$$

are measured under different tuner measurement control words CW1, CW2, CW3 respectively. In the embodiment of the FIG. 6, a plurality of single-instruction control signals S11, S12, S13 (ex. Mobile Industry Processor Interface (MIPI) signals) are sent to trigger the different tuner measurement control words CW1, CW2, CW3. In particular, switching to the tuner measurement control word CW1 is trigger by the single-instruction control signal S11; switching to the tuner measurement control word CW2 is trigger by the single-instruction control signal S12; switching to the tuner measurement control word CW3 is trigger by the single-instruction control signal S13.

The step S110 includes the steps S111 to S116. In the step S111, as shown in the FIG. 7, the SW control module 151 of the Tx modem 150 sends the single-instruction control signal S11 (or S12, S13) to the tuner 120.

Next, in the step S112, as shown in the FIG. 7, the state machine module 121 of the tuner 120 writes the tuner measurement control word CW1 (or CW2, CW3) to a register.

Then, in the step S113, as shown in the FIG. 7, the tuner 120 switches to the tuner measurement control word CW1 (or CW2, CW3) to be set and waits for finishing the steps S114 and S115.

At the same time, in the step S114, as shown in the FIG. 7, the Tx modem 150 stops transmitting signal for the tuner settling time, such as A us.

Afterwards, in the step S115, as shown in the FIG. 7, the feedback path unit 160 measures the reverse RF signal RFr and the forward RF signal RFf for a measurement period, such as B us.

Then, in the step S116, as shown in the FIG. 7, the feedback path unit 160 determines whether the measuring of the reverse RF signal RFr and the forward RF signal RFf for all tuner measurement control words CW1, CW2, CW3 has been finished. If the measurements of the reverse RF signal RFr and the forward RF signal RFf for all tuner measurement control words CW1, CW2, CW3 have been finished, the process proceeds to the step S130; if the measurements of the reverse RF signal RFr and the forward RF signal RFf for all tuner measurement control words CW1, CW2, CW3 have not been finished yet, the process proceeds to the step S111.

As shown in the FIG. 7, the changes for the tuner measurement control words CW1, CW2, CW3 are executed at the Tx gaps among the uplink signal windows (UL).

Before proceeding to the step S130, the step S120 is executed. In the step S120, the feedback path unit 160 obtains the tuner scattering parameters

$${S}_{11}^{1} , \qquad {S}_{11}^{2} , \qquad {S}_{11}^{3} , \qquad {S}_{21}^{1} , \qquad {S}_{21}^{2} , \qquad {S}_{21}^{3} , \qquad {S}_{12}^{1} , \qquad {S}_{12}^{2} , \qquad {S}_{12}^{3} , \qquad {S}_{22}^{1} , \qquad {S}_{22}^{2} , \qquad {S}_{22}^{3} .$$

Next, in the step S130, the feedback path unit 160 calibrates the front-end scattering parameters e₀₀, e₁₀, e₀₁, e₁₁ according to the at least three coupler reflection coefficients

$${Γ}_{MRx}^{1} , {Γ}_{MRx}^{2} , {Γ}_{MRx}^{3}$$

and the tuner scattering parameters

$${S}_{11}^{1} , {S}_{11}^{2} , {S}_{11}^{3} , {S}_{21}^{1} , {S}_{21}^{2} , {S}_{21}^{3} , {S}_{12}^{1} , {S}_{12}^{2} , {S}_{12}^{3} , {S}_{22}^{1} , {S}_{22}^{2} , {S}_{22}^{3} .$$

After executing the step S130, the process proceeds to the steps S140 to S150 for further application.

In the step S140, as shown in the FIG. 7, the feedback path unit 160 measures the antenna reflection coefficient Γ_{Ant}. For example, the antenna reflection coefficient Γ_{Ant} could be derived by the equation (10).

Next, in the step S150, as shown in the FIG. 7, the tuner 120 sets the optimal tuner measurement control word based on the antenna reflection coefficient Γ_{Ant}.

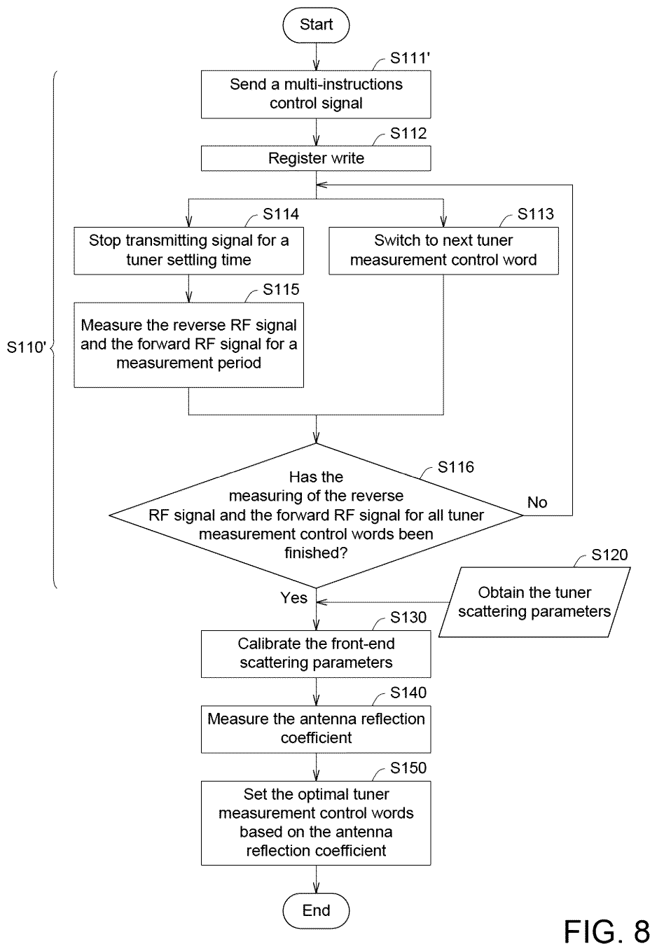

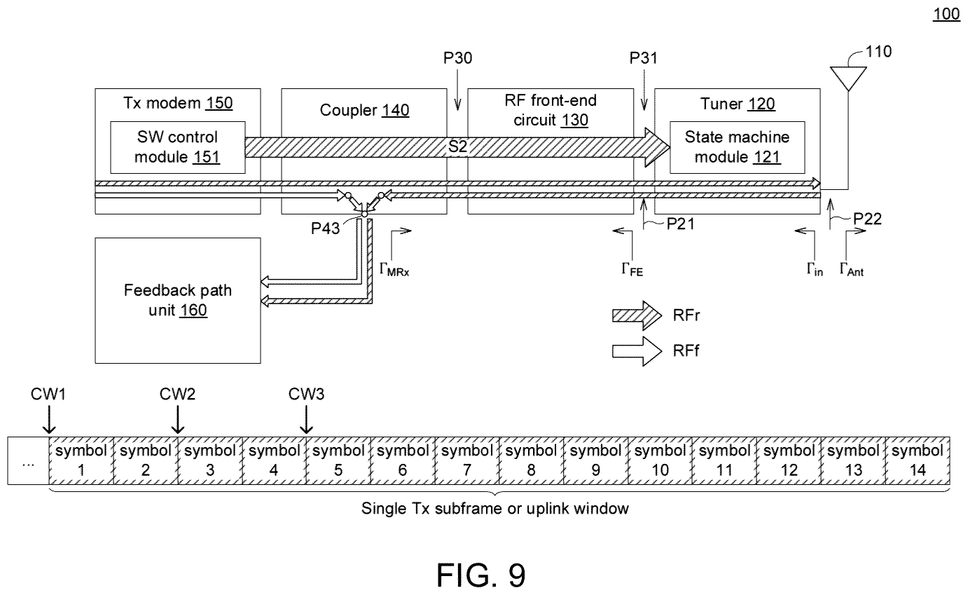

Please refer to FIGS. 8 to 9. FIG. 8 shows a flowchart of a method for calibrating the front-end scattering parameters e₀₀, e₁₀, e₀₁, e₁₁ according to another embodiment of the present disclosure. FIG. 9 illustrates the steps in the FIG. 8. The method for calibrating the front-end scattering parameters e₀₀, e₁₀, e₀₁, e₁₁ in the FIG. 8 includes steps S110′, S120 to S150. The step S110′ includes steps S111′ and S112 to S116. In the embodiment of the FIG. 8, a multi-instructions control signal S2 (ex. Mobile Industry Processor Interface (MIPI) signal) is sent to trigger an automatic tuner measurement control word switching. The tuner setting is switched multiple times by multi-instructions control signal S2, so that an acceptable low software control resolution could be obtained.

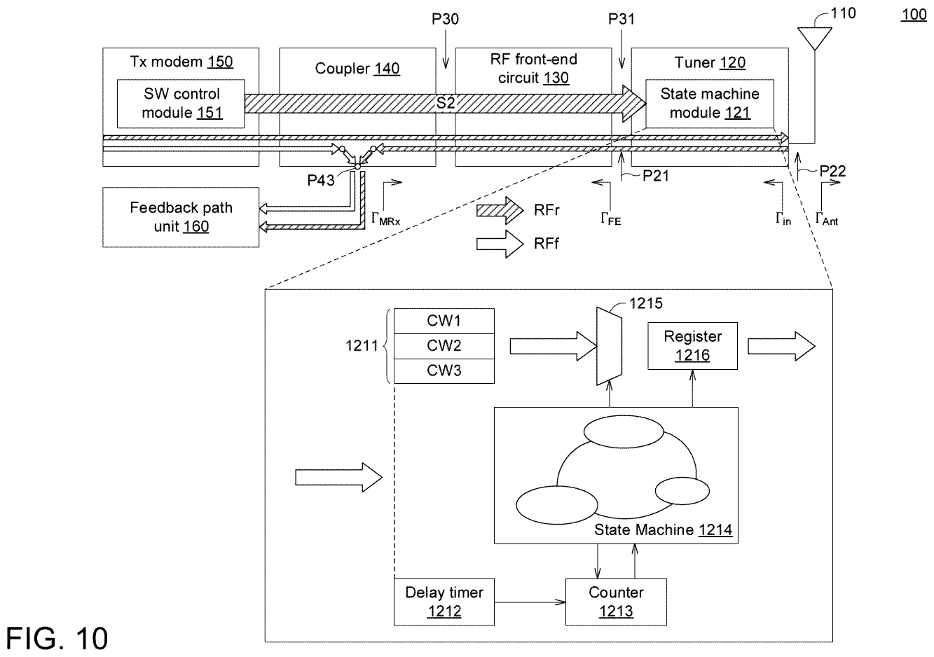

Please refer to FIGS. 8 to 10. FIG. 10 illustrates the hardware features for executing the automatic tuner measurement control word switching according to one embodiment of the present disclosure. As shown in the FIG. 10, the state machine module 121 of the tuner 120 may comprise a register 1211, a delay timer 1212, a counter 1213, a state machine 1214, a MUX 1215 and a register 1216.

In step S110′, as shown in the FIGS. 9 and 10, the feedback path unit 160 measures the at least three coupler reflection coefficients

$${Γ}_{MRx}^{1} , {Γ}_{MRx}^{2} , {Γ}_{MRx}^{3} .$$

The at least three coupler reflection coefficients

$${Γ}_{MRx}^{1} , {Γ}_{MRx}^{2} , {Γ}_{MRx}^{3}$$

are measured under different tuner measurement control words CW1, CW2, CW3 respectively.

The step S110′ includes the steps S111′ and S112 to S116. In the step S111′, as shown in the FIGS. 9 and 10, the SW control module 151 of the Tx modem 150 sends the multi-instructions control signal S2 to the tuner 120.

Next, in the step S112, as shown in the FIGS. 9 and 10, the state machine module 121 of the tuner 120 writes the tuner measurement control words CW1, CW2 and CW3 to a register.

Then, in the step S113, as shown in the FIGS. 9 and 10, the tuner 120 switches to the tuner measurement control word CW1 (or CW2, CW3) to be set and waits for finishing the steps S114 and S115.

At the same time, in the step S114, as shown in the FIGS. 9 and 10, the Tx modem 150 stops transmitting signal for the tuner settling time, such as A us (any positive number of microseconds).

Afterwards, in the step S115, as shown in the FIGS. 9 and 10, the feedback path unit 160 measures the reverse RF signal RFr and the forward RF signal RFf for a measurement period, such as B us (any positive number of microseconds).

Then, in the step S116, as shown in the FIGS. 9 and 10, the feedback path unit 160 determines whether the measuring of the reverse RF signal RFr and the forward RF signal RFf for all tuner measurement control words CW1, CW2, CW3 has been finished. If the measurements of the reverse RF signal RFr and the forward RF signal RFf for all tuner measurement control words CW1, CW2, CW3 have been finished, the process proceeds to the step S130; if the measurements of the reverse RF signal RFr and the forward RF signal RFf for all tuner measurement control words CW1, CW2, CW3 have not been finished yet, the process proceeds to the steps S113, S114.

As shown in the FIG. 9, the changes for the tuner measurement control words CW1, CW2, CW3 are executed at some symbols in a single Rx sub-frame or uplink window. The symbol is defined as the basic unit of data transmitted within a specific time interval, typically represented by the phase or amplitude of a modulated signal.

Before proceeding to the step S130, the step S120 is executed. In the step S120, the feedback path unit 160 obtains the tuner scattering parameters

$${S}_{11}^{1} , {S}_{11}^{2} , {S}_{11}^{3} , {S}_{21}^{1} , {S}_{21}^{2} , {S}_{21}^{3} , {S}_{12}^{1} , {S}_{12}^{2} , {S}_{12}^{3} , {S}_{22}^{1} , {S}_{22}^{2} , {S}_{22}^{3} .$$

Next, in the step S130, the feedback path unit 160 calibrates the front-end scattering parameters e₀₀, e₁₀, e₀₁, e₁₁ according to the at least three coupler reflection coefficients

$${Γ}_{MRx}^{1} , {Γ}_{MRx}^{2} , {Γ}_{MRx}^{3}$$

and the tuner scattering parameters

$${S}_{11}^{1} , {S}_{11}^{2} , {S}_{11}^{3} , {S}_{21}^{1} , {S}_{21}^{2} , {S}_{21}^{3} , {S}_{12}^{1} , {S}_{12}^{2} , {S}_{12}^{3} , {S}_{22}^{1} , {S}_{22}^{2} , {S}_{22}^{3} .$$

After executing the step S130, the process proceeds to the steps S140 to S150 for further application.

In the step S140, as shown in the FIG. 7, the feedback path unit 160 measures the antenna reflection coefficient Γ_{Ant}. For example, the antenna reflection coefficient Γ_{Ant} could be derived by the equation (10).

Next, in the step S150, as shown in the FIG. 7, the tuner 120 sets the optimal tuner measurement control word based on the antenna reflection coefficient Γ_{Ant}.

Based on above, the automatic tuner measurement control word switching is executed to gain some benefits. For example, the automatic tuner measurement control word switching provides an implementation example of the present proposed ideas. The proposed idea is enhanced by allowing for a programmable way perform the calibrations with low control overhead. This is achieved by programming the calibration sequence in advance and triggering the calibration function to operate.

It needs high demand software calculations and could be performed in advance and set as parameters during periods of low control traffic. Only a low traffic trigger is required to start the calibration.

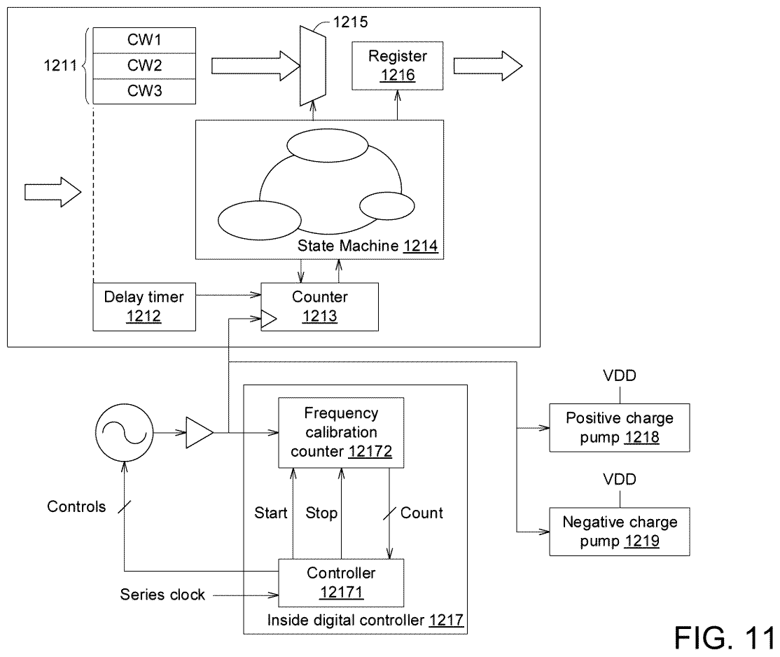

Please refer to FIG. 11, which illustrates a clock calibration for the automatic tuner measurement control word switching according to one embodiment of the present disclosure. To execute the clock calibration, an inside digital controller 1227, a positive charge pump 1228 and a negative charge pump 1229 could be used. The inside digital controller 1227 includes a controller 12271 and a frequency calibration counter 12272. The clock calibration improves timing control accuracy, which is especially important for a self-timed system with high process variability. In the FIG. 11, an implementation example for the clock calibration is provided by using internal clock source. For example, the tuner 120 inherently incorporates an oscillator within their design. The presence of the oscillator is essential for the operation of a charge pump (the positive charge pump 1218 or the negative charge pump 1219). Consequently, there is no necessity for additional circuitry. This approach effectively reutilizes substantial portions of the existing architecture.

Further, a continuous serial clock could be provided as part of successive writes to dummy registers through the feature of extended write supported by MIPI RFFE.

According to the embodiments described above, the calibration of the front-end scattering parameters e₀₀, e₁₀, e₀₁, e₁₁ utilizes the forward RF signal RFf and the reverse RF signal RFr. A novel calibration algorithm and procedure are capable of accurately calibrating the S2P of the front-end in environments with arbitrary and unknown antenna reflection rate, all without requiring the Tx to be set to high isolation. This method employs the tuner 120 for calibration without the need for additional calibration kits, with the tuner 120 set to a low isolation mode. Consequently, this enables signal transmission during calibration, allowing front-end calibration to be conducted concurrently with the mobile device's normal operation. The calibration flow enables real-time measurement of the front-end scattering parameters e₀₀, e₁₀, e₀₁, e₁₁ under network-assigned frequency scenarios, reducing the impact of variations such as part-to-part variation and temperature change. The method involves switching at least three tuner states without affecting signal transmission, thus ensuring accurate S-parameter calibration without using the antenna reflection coefficient Γ_{Ant}.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method for calibrating front-end scattering parameters, comprising:
measuring at least three coupler reflection coefficients under at least three different tuner measurement control words;
obtaining a plurality of tuner scattering parameters corresponding to the at least three different tuner measurement control words; and
calibrating the front-end scattering parameters according to the at least three coupler reflection coefficients, and the tuner scattering parameters.

2. The method according to claim 1, wherein the at least three coupler reflection coefficients are measured offline, real-time, or in a hybrid mode.

3. The method according to claim 2, wherein switching between the tuner measurement control words is controlled by a plurality of single-instruction control signal or is controlled by a multi-instructions control signal.

4. The method according to claim 3, wherein each of the single-instruction control signal and the multi-instructions control signal is a Mobile Industry Processor Interface signal.

5. The method according to claim 1, wherein the at least three coupler reflection coefficients are measured by a feedback path, and a RF signal transmitting path in both of an RF front-end circuit (RFFE) and a transmitting (Tx) modem is fixed when measuring the at least three coupler reflection coefficients.

6. The method according to claim 1, wherein the at least three coupler reflection coefficients are measured within 0.1 second when the at least three coupler reflection coefficients are measured real-time.

7. The method according to claim 1, wherein the at least three coupler reflection coefficients are measured under a constant antenna reflection coefficient.

8. The method according to claim 1, wherein each of the at least three coupler reflection coefficients is measured when an RFFE input port of a RF front-end circuit (RFFE) connects with a coupler and an RFFE output port of the RFFE connects with a tuner.

9. The method according to claim 1, further comprising:
calibrating an antenna reflection coefficient according to the calibrated front-end scattering parameters.

10. The method of claim 1, wherein in the step of calibrating the front-end scattering parameters,
the front-end scattering parameters are calibrated by
$$\{ \begin{matrix}\frac{\frac{{Γ}_{MRx}^{1} - y}{x - z {Γ}_{MRx}^{1}} - {S}_{11}^{1}}{{S}_{12}^{1} {S}_{21}^{1} + {S}_{22}^{1} ( \frac{{Γ}_{MRx}^{1} - y}{x - z {Γ}_{MRx}^{1}} - {S}_{11}^{1} )} - \frac{\frac{{Γ}_{MRx}^{2} - y}{x - z {Γ}_{MRx}^{2}} - {S}_{11}^{2}}{{S}_{12}^{2} {S}_{21}^{2} + {S}_{22}^{2} ( \frac{{Γ}_{MRx}^{2} - y}{x - z {Γ}_{MRx}^{2}} - {S}_{11}^{2} )} = 0 \\ \frac{\frac{{Γ}_{MRx}^{2} - y}{x - z {Γ}_{MRx}^{2}} - {S}_{11}^{2}}{{S}_{12}^{2} {S}_{21}^{2} + {S}_{22}^{2} ( \frac{{Γ}_{MRx}^{2} - y}{x - z {Γ}_{MRx}^{2}} - {S}_{11}^{2} )} - \frac{\frac{{Γ}_{MRx}^{3} - y}{x - z {Γ}_{MRx}^{3}} - {S}_{11}^{3}}{{S}_{12}^{3} {S}_{21}^{3} + {S}_{22}^{3} ( \frac{{Γ}_{MRx}^{3} - y}{x - z {Γ}_{MRx}^{3}} - {S}_{11}^{3} )} = 0 ; \\ \frac{\frac{{Γ}_{MRx}^{3} - y}{x - z {Γ}_{MRx}^{3}} - {S}_{11}^{3}}{{S}_{12}^{3} {S}_{21}^{3} + {S}_{22}^{3} ( \frac{{Γ}_{MRx}^{3} - y}{x - z {Γ}_{MRx}^{3}} - {S}_{11}^{3} )} - \frac{\frac{{Γ}_{MRx}^{1} - y}{x - z {Γ}_{MRx}^{1}} - {S}_{11}^{1}}{{S}_{12}^{1} {S}_{21}^{1} + {S}_{22}^{1} ( \frac{{Γ}_{MRx}^{1} - y}{x - z {Γ}_{MRx}^{1}} - {S}_{11}^{1} )} = 0\end{matrix}$$
$${Γ}_{MRx}^{1} , {Γ}_{MRx}^{2} and {Γ}_{MRx}^{3}$$
are three coupler reflection coefficients measured under three different tuner measurement control words;
$$x = {e}_{01} {e}_{10} - {e}_{00} {e}_{11} ;$$
$$y = {e}_{00} ;$$
$$z = - {e}_{11} ;$$
e₀₀ is a reflection coefficient at an RFFE input port of an RF front-end circuit (RFFE), representing a proportion of a wave entering the RFFE input port of the RFFE that is reflected back to the RFFE input port of the RFFE;
e₁₀ is a transmission coefficient from the RFFE input port of the RFFE to an RFFE output port of the RFFE, representing a proportion of a wave entering the RFFE input port of the RFFE that is transmitted to the RFFE output port of the RFFE;
e₀₁ is a transmission coefficient from the RFFE output port of the RFFE to the RFFE input port of the RFFE, representing a proportion of a wave entering the RFFE output port of the RFFE that is transmitted to the RFFE input port of the RFFE;
e₁₁ is a reflection coefficient at the RFFE output port of the RFFE, representing a proportion of a wave entering the RFFE output port of the RFFE that is reflected back to the RFFE output port of the RFFE;
$${S}_{11}^{1} , {S}_{11}^{2} , {S}_{11}^{3} , {S}_{21}^{1} , {S}_{21}^{2} , {S}_{21}^{3} , {S}_{12}^{1} , {S}_{12}^{2} , {S}_{12}^{3} , {S}_{22}^{1} , {S}_{22}^{2} and {S}_{22}^{3}$$
are tuner scattering parameters corresponding to the tuner measurement control words which are different.

11. A user equipment, comprising:
an antenna;
a tuner, connected to the antenna, wherein the tuner is used for switching at least three different tuner measurement control words;
an RF Front-end circuit (RFFE), connected to the tuner;
a coupler, connected to the RFFE;
a transmitting (Tx) modem, connected to the coupler; and
a feedback path unit, connected to the RF Front-end circuit, wherein the feedback path unit is used to measure at least three coupler reflection coefficients under the at least three different tuner measurement control words, the feedback path unit is further used to obtain a plurality of tuner scattering parameters corresponding to the at least three different tuner measurement control words, and the feedback path unit is further used to calibrate the front-end scattering parameters according to the at least three coupler reflection coefficients, and the tuner scattering parameters.

12. The user equipment according to claim 11, wherein the at least three coupler reflection coefficients are measured offline, real-time, or in a hybrid mode.

13. The user equipment according to claim 12, wherein the turner switches between the tuner measurement control words by a plurality of single-instruction control signal or by a multi-instructions control signal.

14. The user equipment according to claim 13, wherein each of the single-instruction control signal and the multi-instructions control signal is a Mobile Industry Processor Interface signal.

15. The user equipment according to claim 11, wherein a RF signal transmitting path in both of the RFFE and the transmitting modem is fixed when measuring the at least three coupler reflection coefficients.

16. The user equipment according to claim 11, wherein the at least three coupler reflection coefficients are measured within 0.1 second when the at least three coupler reflection coefficients are measured real-time.

17. The user equipment according to claim 11, wherein the at least three coupler reflection coefficients are measured under a constant antenna reflection coefficient.

18. The user equipment according to claim 11, wherein each of the at least three coupler reflection coefficients is measured when an RFFE input port of the RFFE connects with the coupler and an RFFE output port of the RFFE connects with the tuner.

19. The user equipment according to claim 11, wherein the feedback path unit is further used to calibrate an antenna reflection coefficient according to the calibrated front-end scattering parameters.

20. The user equipment according to claim 11, wherein the feedback path unit calibrates the front-end scattering parameters by
$$\{ \{ \begin{matrix}\frac{\frac{{Γ}_{MRx}^{1} - y}{x - z {Γ}_{MRx}^{1}} - {S}_{11}^{1}}{{S}_{12}^{1} {S}_{21}^{1} + {S}_{22}^{1} ( \frac{{Γ}_{MRx}^{1} - y}{x - z {Γ}_{MRx}^{1}} - {S}_{11}^{1} )} - \frac{\frac{{Γ}_{MRx}^{2} - y}{x - z {Γ}_{MRx}^{2}} - {S}_{11}^{2}}{{S}_{12}^{2} {S}_{21}^{2} + {S}_{22}^{2} ( \frac{{Γ}_{MRx}^{2} - y}{x - z {Γ}_{MRx}^{2}} - {S}_{11}^{2} )} = 0 \\ \frac{\frac{{Γ}_{MRx}^{2} - y}{x - z {Γ}_{MRx}^{2}} - {S}_{11}^{2}}{{S}_{12}^{2} {S}_{21}^{2} + {S}_{22}^{2} ( \frac{{Γ}_{MRx}^{2} - y}{x - z {Γ}_{MRx}^{2}} - {S}_{11}^{2} )} - \frac{\frac{{Γ}_{MRx}^{3} - y}{x - z {Γ}_{MRx}^{3}} - {S}_{11}^{3}}{{S}_{12}^{3} {S}_{21}^{3} + {S}_{22}^{3} ( \frac{{Γ}_{MRx}^{3} - y}{x - z {Γ}_{MRx}^{3}} - {S}_{11}^{3} )} = 0 ; \\ \frac{\frac{{Γ}_{MRx}^{3} - y}{x - z {Γ}_{MRx}^{3}} - {S}_{11}^{3}}{{S}_{12}^{3} {S}_{21}^{3} + {S}_{22}^{3} ( \frac{{Γ}_{MRx}^{3} - y}{x - z {Γ}_{MRx}^{3}} - {S}_{11}^{3} )} - \frac{\frac{{Γ}_{MRx}^{1} - y}{x - z {Γ}_{MRx}^{1}} - {S}_{11}^{1}}{{S}_{12}^{1} {S}_{21}^{1} + {S}_{22}^{1} ( \frac{{Γ}_{MRx}^{1} - y}{x - z {Γ}_{MRx}^{1}} - {S}_{11}^{1} )} = 0\end{matrix}$$
$${Γ}_{MRx}^{1} , {Γ}_{MRx}^{2} and {Γ}_{MRx}^{3}$$
are three coupler reflection coefficients measured under three different tuner measurement control words;
$$x = {e}_{01} {e}_{10} - {e}_{00} {e}_{11} ;$$
$$y = {e}_{00} ;$$
$$z = - {e}_{11} ;$$
e₀₀ is a reflection coefficient at an RFFE input port of an RF front-end circuit (RFFE), representing a proportion of a wave entering the RFFE input port of the RFFE that is reflected back to the RFFE input port of the RFFE;
e₁₀ is a transmission coefficient from the RFFE input port of the RFFE to an RFFE output port first RFFE the RFFE, representing a proportion of a wave entering the input port of the RFFE that is transmitted to the RFFE output port of the RFFE;
e₀₁ is a transmission coefficient from the RFFE output port of the RFFE to the RFFE input port of the RFFE, representing a proportion of a wave entering the RFFE output port of the RFFE that is transmitted to the RFFE input port of the RFFE;
e₁₁ is a reflection coefficient at the RFFE output port of the RFFE, representing a proportion of a wave entering the RFFE output port of the RFFE that is reflected back to the RFFE output port of the RFFE;
$${S}_{11}^{1} , {S}_{11}^{2} , {S}_{11}^{3} , {S}_{21}^{1} , {S}_{21}^{2} , {S}_{21}^{3} , {S}_{12}^{1} , {S}_{12}^{2} , {S}_{12}^{3} , {S}_{22}^{1} , {S}_{22}^{2} and {S}_{22}^{3}$$
are tuner scattering parameters corresponding to the tuner measurement control words which are different.
